(19) United States
(12) Patent Application Publication
(10) Pub. No.: US 2023/0393901 A1
(43) Pub. Date: Dec. 7, 2023

(54) Method for controlling and regulating data for generating a representation, in particular a virtual representation, via a client, and method for managing data on the internet for generating a representation, in particular a virtual representation, via a client

(71) Applicants: Albert Luntsch, Trumau (AT); Gerald Schaller, Brunn am Gebirge (AT)

(72) Inventor: Albert LUNTSCH, Trumau (AT)

(73) Assignees: Albert Luntsch, Trumau (AT); Gerald Schaller, Brunn am Gebirge (AT)

(21) Appl. No.: 18/032,892

(22) PCT Filed: Oct. 21, 2021
(86) PCT No.: PCT/AT2021/060391

§ 371 Date: Apr. 20, 2023

(30) Foreign Application Priority Data
Oct. 27, 2020 (AT) A 241/2020

(51) Int. Cl. G06F 9/50; H04L 67/131

(52) U.S. Cl. CPC G06F 9/5055; H04L 67/131

(57) ABSTRACT

Method for controlling and regulating data for generating a representation via a client. Method includes opening the client, establishing a connection of the medium with a server via the internet, requesting data, and loading the data onto the medium for use by the client. After opening the client or when requesting data from the internet, the client obtains access to the hardware of the executing medium and the performance data of the medium are determined by the client or these performance data are transmitted from the medium to the client. Client compares the performance data of the medium with the resources required for the requested data, which are transmitted to the client by transmission of the protocol when the client makes the query, whereupon, if the performance data of the medium are too low, additional external performance resources of one or more users, respectively, are activated by the client.

The present invention relates to a method for controlling and regulating data for generating a representation, in particular a virtual representation, via a client, in particular a software, a browser, an app, on a medium, in particular a computer, tablet or cellphone, smart TV, VR glasses, etc., comprising at least the steps of:
Opening a client, in particular a software, a browser, or an app, at a medium;
establishing a connection of the medium with a server, in particular a web server, via the internet
requesting data, in particular by transmission of a protocol, and
loading the data onto the medium for use by the client,
   as well as a method for managing data on the internet for generating a representation, in particular a virtual representation, via a client, in particular a software, a browser, an app, on a medium, in particular a computer, tablet or cellphone, smart TV, VR glasses, etc., comprising at least the steps:
Opening a client, in particular a software, a browser, or an app, on a medium;
establishing a connection of the medium with a server, in particular a web server, via the internet;
requesting data, in particular by transmission of a protocol, and
loading the data onto the medium for use by the client, as described in claims 1 and 10.

The internet is used, among other things, as a platform for the storage of data, which are invoked and displayed via a browser. Several options for displaying web pages or their functions, respectively, in particular shops, images, videos, etc., are known from the art. In this case, the browser loads the data from the server over the internet using the HTTP format (Hypertext Transfer Protocol), in particular WWW-format (world wide web) into the memory of the client, i.e. the device used, such as cellphone, tablet, computer, etc. The paramount functions are to request the files from the web server and load them into the browser. The browser then provides the display of texts and images and takes care of the playback of audio and video data.

The disadvantage of this is that with today's internet the data must first be loaded from the server, in particular web server, before it is displayed on the browser or other display devices. If the data are very large, as is the case with virtual representations, it often takes a long time for the user to load the data first before they are displayed.

Many attempts are made to circumvent such problems by loading only a small part of the total amount of data first, whereupon the display starts. However, very often it happens that the reloading of the data causes interruptions, in particular stuttering, during playback. Also, it happens very often that the transfer speed changes during the download, in particular slows down, so that a complete standstill of the display process occurs, which is very annoying for the user.

Another disadvantage is that often large amounts of data, such as virtual representations, are invoked using clients, in particular devices, whose hardware, in particular processors and memory, are insufficient, whereby very slow or jerky processing or representation, respectively, result.

It is therefore the objective of the present invention to create a method for controlling and regulating the data for generating a representation, in particular a virtual representation, via a client, whereby on the one hand the above-mentioned disadvantages are prevented, and on the other hand the loading time of large amounts of data is shortened.

The objective is achieved by the invention.

The method according to the present invention is characterized in that after opening the client or when requesting data from the internet, in particular a server, the client obtains access to the hardware of the executing medium, and the performance data of the medium are determined by the client or these performance data are transmitted from the medium to the client, whereupon the client compares the performance data of the medium with the resources required for the requested data, which are transmitted to the client by transmission of the protocol when the client makes the query, whereupon, if the performance data of the medium are insufficient, additional external performance resources of one or more users are activated by the client.

The advantage of this is that the available performance resources of the client or device, respectively, being used are first determined, whereupon the lacking resources of external components or clients are subsequently made available in order to ensure a smooth presentation.

Here, when the download of the data is started, the browser is first told which resource is needed for smooth presentation or playback, respectively. In order to send the corresponding information to the browser, a new type of protocol is used, namely VRTP—Virtual Reality Transfer Protocol, which is used specifically for large amounts of data, in particular for a virtual world. VRTP is the communication protocol in the Virtual Reality Web (VRW). The paramount functions are to request the files from the web server and load them into the browser 10 or client 2, e.g. of VR glasses. The client or VR glasses, respectively, then provide the processing of graphics and take care of the display of virtual components. Here it is possible that for the processing of the data, in particular the amount of data, an own client, such as for example a software, a browser, an app, on a medium, in particular computer, tablet or cellphone, smart TV, VR glasses, of the user or alternatively external so-called users or hardware, respectively, such as for example web servers, clouds, computer, tablet or cellphone, smart TV, VR glasses, etc., of other users are used.

Advantageous embodiments are also such in which the lacking performance resources are distributed by the client among one or more users. This ensures that if the own performance resources are too low, for example in the case of an old cellphone, additional performance resources are made available to the so-called users via external components, so that the processing of the data volume is carried out in parallel by the own client, i.e. device, and the external components, i.e. users. This makes it possible for low-resource devices to be used in the new virtual world.

Nowadays, due to ever cheaper and faster memory chips and processors, the representations on the web pages are presented in virtual form, in particular as a virtual model. On the one hand, this allows the customer to view presented products as a virtual 3d model, and on the other hand, the customer can take a tour of the company or store through a virtual shop or building, respectively.

Thus even individual virtual worlds are already provided and/or present, respectively, in which a variety of businesses are arranged, which are connected by ways and/or roads, respectively, so that the customer can visit a wide variety of shops, businesses, companies, etc., respectively. Thus, a virtual map is created, into which sights are also integrated.

However, advantageous embodiments are also such in which the data are processed by one or more users in parallel or sequentially when instructed by the client. This ensures that the data volume is processed as quickly as possible, so that the preferably virtual playback can start immediately. Parallel processing can therefore take place because the required data are preferably stored multiply at different storage locations, in particular web servers, as will be described later. Also, the data are stored in smaller units to be able to use as many users as possible at the same time.

Advantageous embodiments are also such in which different users are activated for different performance resources, wherein users are activated for the performance resource for additional storage media and/or a performance resource for additional computing power. This ensures that when the individual data packets are started, special information is stored that comprise the required resources, in particular processor power and/or memory capacity, so that the appropriate user is activated depending on the requirement.

Advantageous embodiments are such in which each user sends information regarding the performance resources it has made available to the client when the client makes a query. This ensures that the data can be easily combined into one large package, wherein simultaneous processing is possible in a wide variety of users. This special information can include, for example, the sequence, the storage of the next package, etc., so that an optimally fast loading process is ensured.

However, it is also advantageous to take measures in which a user, when activating his or her performance resources for other users or media, respectively, deposits his or her provided performance resource in a database on a server. This ensures that when a large volume of data is launched for displaying a virtual world, for example, the best possible users can be selected centrally or decentrally in the database. At the same time, it is advantageous if the availability, in particular the download speed, of the stored services can be queried in the database so that the best possible connections can be selected. Here the status of the connection speed is constantly updated to take into account the load on the internet.

Advantageous embodiments are also such in which the client handles distribution of the performance resources to a wide variety of users. This ensures that the client can determine the fastest possible download speed and then downloads and processes the individual data packets at the highest possible speed.

Advantageous embodiments are such in which the request for data is made via the Virtual Reality Transfer Protocol (VRTP-protocol). This ensures that the pivotal information, such as the stored data packets, the required performance resources, etc., is automatically transmitted.

Furthermore, the objective of the present invention is achieved by splitting the data into several small data packets with low data volumes on several different servers, which are loaded sequentially or in parallel from the different servers when they are called up and are combined by the client.

The advantage here is that in each case only very small data packets are downloaded via the internet so the transmission speed does not collapse, i.e. the transmission speed is stably high during the download of the small data packet and this data packet can therefore be loaded very quickly.

In the prior art, mainly large contiguous data packets are offered or made available, respectively, for download, which means that it is very often the case that the transfer speed changes during the transfer, in particular slows down, whereby it appears to the user as if the transfer has frozen and the user then aborts the download and restarts.

Another advantage is that several identical data packets with a small data size are stored on several different clients or servers, respectively, so that the browser can choose the best possible and most stable speed for the download.

Especially in the case of virtual representations, which are often viewed by users via VR glasses, it is necessary to ensure stutter-free viewing of the virtual world or representation, respectively, which is achieved due to the distribution of the data packets to a large number of small units that are loaded into the client at a high download speed. It is possible that several such small data packets are stored on a client or server, respectively, but only one data packet is loaded from it when the transmission speed deteriorates, so that the next data packet is loaded from another storage medium.

The browser is designed in such a way that, on the one hand, it provides the download and processing of the data packet, in particular the representation, and, on the other hand, it simultaneously determines the next data packet with the highest transmission speed. For this purpose, the data packets have a defined area in which, on the one hand, the next data packet is defined and where this data packet is stored everywhere.

Advantageous embodiments are such in which each data packet is stored several times, in particular in parallel, on several different servers, wherein the data packet is loaded from the server with the fastest data connection. This ensures that the browser can select the best possible connection. Furthermore, the distribution of several identical data packets to different servers or storage devices, respectively, ensures that when several people download data, they automatically access the various stored data packets, since their server determines the download or transmission speed, respectively, before the download, i.e. when one and the same data packet is downloaded by different people, the browser recognizes which data packet is currently being downloaded by someone and thus selects another data packet that is not currently being downloaded. However, if all available equal data packets are occupied with a download, the next available data packet is selected by the browser. Here it is possible that during the download of a data packet this is marked, or the still-needed download or waiting time is stored, respectively, so that the browser can select the fastest possible connection.

Advantageous embodiments are such in which each data packet contains information, in particular server addresses, for the next data packets. This ensures that during the download by the browser the latter receives the information which data packet will be needed next. Thus, the complete software can be easily assembled from a large number of small data packages. According to the present invention, it is also provided that this information, in particular that of the stored same data packets, is automatically updated as soon as a data packet is newly or additionally stored on a server or client, i.e., 92z,999

Advantageous embodiments are such in which the medium from which a data packet is requested via the client serves as an additional storage medium for this or several data packets. This ensures that the clients that have downloaded a data packet are also available as a storage location, wherein this information is updated accordingly. Thus, the data packets are duplicated automatically, wherein this can be activated or deactivated, respectively, by the user of the client. If a user activates the storage of data packets, the user, in particular the client, receives a virtual reward for each download from his or her client. However, only a limited portion of the client's available memory is automatically used as a possible storage location, so the client can still be fully used by the user.

Finally, advantageous embodiments are such in which the request for data is made using the Virtual Reality Transfer Protocol (VRTP protocol). This ensures that all the necessary information, such as the next data packet(s), the storage locations, the data size, etc., is available in order to achieve the downloading and assembly of the individual data packets by the browser as quickly as possible.

The invention will now be explained in more detail by reference to the exemplary embodiments illustrated in the drawings.

The figures show:

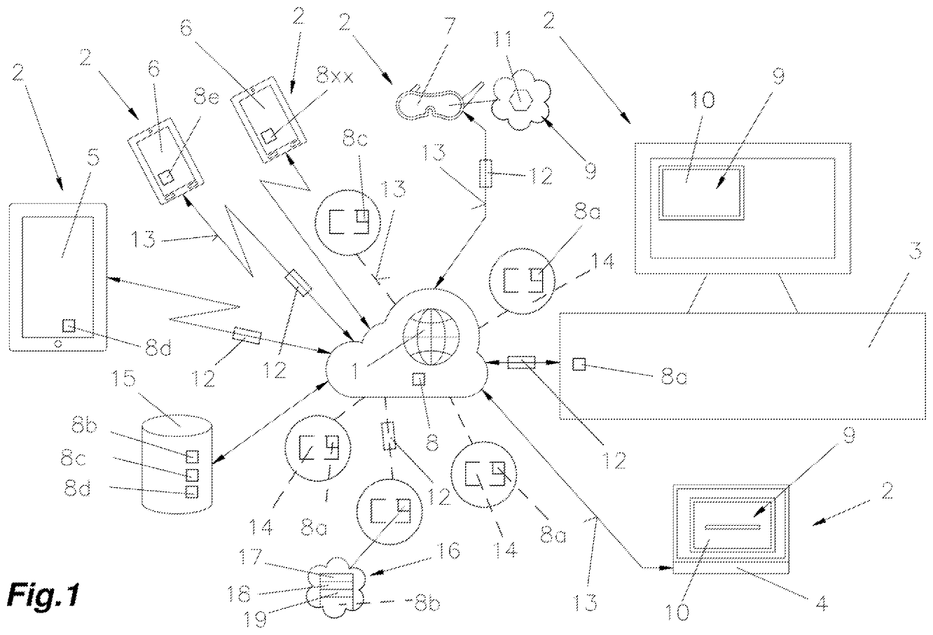

FIG. 1 a process diagram according to the present invention of a browser in connection with the internet, simplified, for illustrative purposes only;

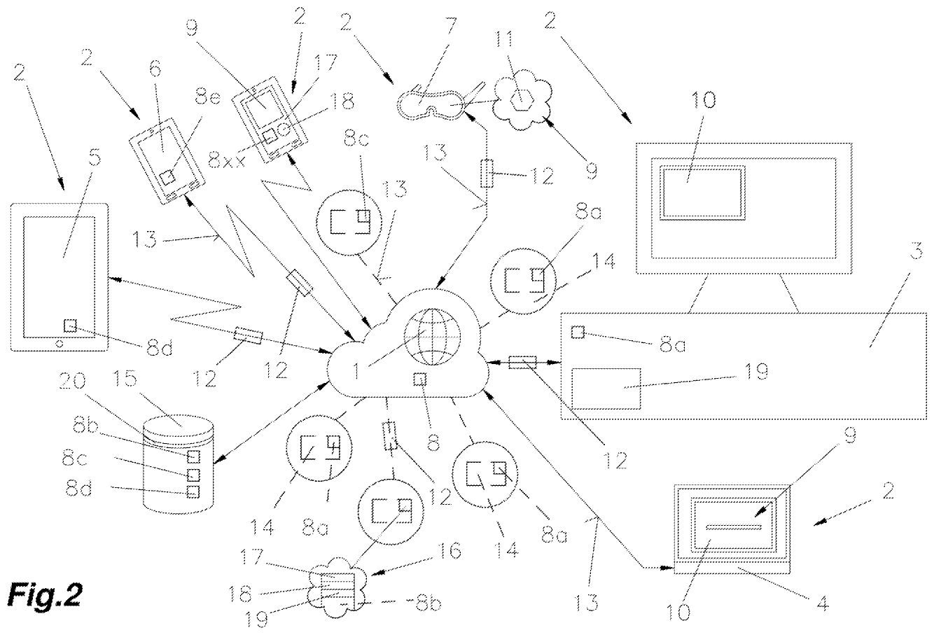

FIG. 2 a schematic representation

It should be stated by way of introduction that, in the individual embodiments, identical parts are provided with the same reference numbers or same component designations, respectively, wherein the disclosures contained in the entire description can, by analogy, be transferred to identical parts with identical reference numbers or identical component designations, respectively. The position details selected in the description, such as, e.g., top, bottom, lateral, etc., likewise relate to the figure described, and in the event of a change of position, they are to be transferred to the new position by analogy. Individual features or feature combinations from the exemplary embodiments shown and described may also represent independent inventive solutions.

FIGS. 1 and 2 show schematic virtual representations of an internet 1 with clients 2 connected to it. Clients 2 are the terminal devices, in particular computers 3, laptops 4 (not shown), tablets 5, cellphones 6, VR glasses 7, etc., that load data 8, in particular individual data packets 8a to 8xx, of an application or software, respectively, via the internet 1. Preferably, corresponding media 9, in particular browsers 10 or software 11, etc., are installed on the individual clients 2, which on the one hand establish the connection to the internet 1 and on the other hand manage the data 8 required for the intended display.

According to the present invention, the media 9 of the individual clients 2 are connected to the internet 1 via a VRTP protocol 12, i.e. the Virtual Reality Transfer Protocol 12. Here the connection 13 of the medium 9 of the client 2 with the internet 1, in particular with servers or web servers 14, respectively, connected therewith, storage media 15, or other client 2, takes place using a wide variety of possibilities known from the prior art, like fiber optics, DSL, radio, TV, etc., whereby the data 8 or data packets 8a to 8xx correspond to a download or upload to be accomplished. Here, the most important functions of the VRTP protocol 12 are to request the data 8 from a web server 14 or client or storage medium 15 or client 2 and to load it in the medium 9, in particular in the browser 10 or in the software 11, whereupon the medium 9 subsequently provides and manages or administers, respectively, the processing of the data 8. It is essential that the data packets 8a to 8xx, i.e. the download, be made available as quickly as possible to enable a “stutter-free” display. This is necessary in particular for representations of graphics in the virtual world, for which the new VRTP protocol 12 was created.

For this purpose, it is possible that special media 9 or a medium 9, respectively, in particular a browser 10, such as the “Encores” browser 10, is installed' on the clients 2, which can use both the standardized HTTP protocol, i.e. Hypertext Transfer Protocol, and the new VRTP protocol 12. Similarly, it is possible that for other browsers 10, such as Chrome, Edge, Firefox, etc., that currently do not support the novel VRTP Protocol 12, appropriate plug-in software can be loaded and installed so that subsequently these browsers 10 can also use the novel VRTP Protocol 12. Basically, it should be said that the medium 9, in particular the browser 10 or software 11, for the VRTP protocol 12 can also process and display data 8 of the HTTP protocol, so that no separate media 9 is needed at the client 2 for these data 8.

As known from the prior art, the data exchange or sequence takes place in such a way that when a client 2 or in particular a software 11, respectively, and/or a browser 10, or an app, is opened, the establishment of a connection 13 of the medium 9 with the interne 1, in particular a server or web server 14, respectively, storage medium 15 or other client 2, via the internet 1, a request for data takes place, in particular by transmission of a protocol, and then the loading of the data onto the medium 9 for use by the client 2 takes place, as is also known from the prior art.

According to the present invention, it is now envisaged that the data 8 are split into several small data packets 8a to 8xx with small data volumes on several different servers 14, which are loaded sequentially or in parallel from the different servers 14 or storage media 15 or other clients 2 when they are called up and are assembled by the own client 2, in particular the medium 9. This ensures that the client 2, in particular the medium 9, in each case processes only small data packets 8a to 8xx consecutively or in parallel, depending on the hardware of the client 2, so that they are downloaded very quickly at a constant transmission speed. Also, the display or processing, respectively, of the data packets 8a to 8xx can be performed after the loading of each data packet 8a to 8xx, so that the user of the client 2 does not have to wait until all data 8 are loaded, but the data 8 are used already during the loading process.

As can be seen from the schematic representation in FIG. 1, each data packet 8a to 8xx can be stored several times, in particular in parallel, on several different servers 14, storage media 15 or other clients 2, wherein the loading of the currently required data packet 8a, for example, takes place from that server 14, storage medium 15 or client 2 with the fastest data connection 13, i.e., that the individual data packets 8a to 8xx (not limited to this number) are stored thousands of times on a variety of web servers 14, storage media 15 or other available clients 2 and preferably always that data packet 8a to 8xx is loaded for which the fastest data connection 13 exists. This also means that a download is not limited to a single storage location, so that a large number of users can simultaneously load the correspondingly required data package 8a to 8xx in parallel from a wide variety of sources.

To make this possible, the individual data packets 8a to 8xx have special information 16, such as at least one or more server addresses 17 for the next packet, a data packet number 18 or name 18, respectively, the required performance data 19 and the data 8 for the medium. This may include other special information 16, such as packet size, etc., to enable the fastest possible assembly of the many individual data packets 8a to 8xx. It is advantageous if, when one or more data packets 8a to 8xx are created, as may be the case, for example, as a result of storage operations during use, the packet size is or becomes, respectively, predetermined so that the data 8 to be stored are distributed accordingly by the medium 9.

It has been found to be advantageous that the particular client 2 or medium 9, respectively, which wishes to use or execute the software from the individual data packets 8a to 8xx is simultaneously used as a further storage location for one or more data packets 8a to 8xx, i.e. when the software or application, respectively, is called up, part of the existing memory of the client 2 is available as a new storage location for one or more data packets 8a to 8xx. The user preferably has the option of activating or deactivating this via the settings in his or her device or client, respectively. If a user has activated the function as a storage client, the. software or application, respectively, determines the resources or performance data, respectively, of the client 2 and a part of the available storage volume is defined or made available as a storage medium for data packets 8a to 8xx of the software or application, respectively, so that this storage volume can then be used. This ensures that a large number of servers or clients are available for storage of small data packets 8a to 8xx.

However, in order to process such a high amount of data 8 of a virtual application or software, it is also necessary that the client 2, which retrieves and wants to process these data 8 of the virtual application or software, respectively, should also have a corresponding hardware, in particular hardware resource, which is often not the case with older clients 2 or devices 2.

In order to solve this problem of insufficient hardware resource or power, respectively, a method according to the present invention for controlling and regulating the data for generating an in particular virtual representation via a client, in particular a software, a browser, an app, on a medium 9, in particular computer 3, laptop 4, tablet 5 or cellphone 6, smart TV, VR glasses 7, etc., is provided, in which, after opening the client 2 or when requesting data 8 from the internet 1, in particular a server 14 or a storage medium 15 or another client 2, the client 2 obtains access to the hardware of the executing medium 9, and the performance data of the medium 9 or client 2, respectively, are determined by the client 2, or these performance data or resources, respectively, are transmitted from the medium 9 to the client, whereupon the client 2 compares the performance data of the medium 9 with the resources required for the requested data, which are transmitted to the client 2 by transmission of the protocol, in particular the information 16, when the client makes the query, whereupon, if the performance data of the medium 9 are too low, additional external performance resources of one or more clients 2 or users are activated by the client 2, i.e., that additional hardware performance or hardware resources are used via the internet 1 by one or more other clients 2 for processing the data 8 for the application or software, and thus the computing power and memory performance of the client 2 are compensated, so that the data 8 of the application or software can be displayed without stutter. This ensures that even older clients 2 with insufficient performance resources can use the new preferably virtual media 9 without experiencing so-called jerky or jumpy playback or even hang-ups, respectively.

If a user of a client has activated provision of a part of its performance resource in its settings, the information 16 is integrated into corresponding data packets 8a to 8xx of the application or software, respectively, so that, if required by a client 2, the information 16 is read and a corresponding connection 13 is established so that a part of the computing power is now shared by its own client 2 and the client 2 coupled via the connection 13. In this context, it is possible that not only a connection 13 with one further client 2 but with several clients 2 is possible, which share the computing power, wherein the own client 2 always serves as the display client 2 on which the medium 9, in particular the application or software, respectively, runs. This solution ensures that all clients 2, even those that are already very old and whose performance is much lower, can use the new virtual media 9.

In this context, it is also possible that different clients 2 or so-called users 2 (users), respectively, are specifically used for differently required services, for example for display or computation, i.e., different users or clients 2, respectively, are activated for different performance resources, wherein users are activated for the performance resource for additional storage media and/or a performance resource for additional computing power. What a client 2 can be used for is determined during the analysis of the client 2, in particular its resources, and is stored in the information 16 so that this information 16 is available to all clients 2 that read the information 16.

Here it is also possible that a central or decentralized database, for example the storage medium 15, can be used for the storage of all information 16, so that first a connection 13 of the medium 9 to the database 15 is established and all necessary information 16 is queried there, whereupon the medium 9 establishes the connections 9 to the individual clients 2 and the data packets 8a to 8xx.

In order for a user to agree to storage of data packets 8a to 8xx and/or to make available part of his performance resources of his device, the media 9 working with this system, in particular applications or software, are coupled with a reward system in which each client, in particular its owner, receives a reward, preferably in the form of virtual money or Bitcoin, respectively, when retrieving one or more data packets 8a to 8xx, and/or making available his performance resource, which he can exchange for real money.

As mentioned before, the new VRTP protocol 12 works somewhat differently than the traditional HTTP protocol does. In the new VRTP protocol 12, computing power is automatically shared between the server 14 and/or other clients 2 and its own client 2, if necessary, wherein the client 2 or medium 9 (browser 10/VR glasses 7 or app), respectively, has access to the device power and shares the required computing power (edges) between a contingent of performance resources of other clients 2 or server 14, respectively, and the end device, i.e., its own client 2. Performance resources include: Cloud servers or web servers 14, graphics card mining and mining pools provided by users of their unused terminals or clients 2, respectively, such as laptops 4 and cellphones 6. This generates a high number of performance resources, since many users provide the power of their device 2 that is not needed at the moment, wherein less to no performance resources of their device 2 or clients, respectively, are made available in the case of personal demand. For example, this can be used to provide the graphics power of the performance resources then for the medium 9 the application 9—VRW (Virtual Reality World)—to compensate for inequalities between too weak output devices 2 of the clients and to ensure a minimum performance or display, respectively, on all terminals or clients when using the VRW 9.

So-called miners, mining pools, PC and cellphone owners can create an account in the VRW so that they can be provided with the required computing power. In return for providing this computing power, they receive an internal unit of account, which they can spend in the VRW or have exchanged for their respective national currency.

The structure and content in the Virtual Reality Web 9 (VRW) medium 9 is such that a new innovative and interactive world is presented in which customers or companies can buy and later also sell or rent one or more properties. Thus, in the VRW medium 9 each m² is a coordinate, and domains are the associated directions, wherein the plots are a kind of interactive website on which everything is possible.

Where before you used to have a furniture store and a corresponding website on the WWW, you now have the possibility to present your website interactively in VR (virtual reality) on the new VRW medium 9. Thus, customers no longer visit the conventional website with store but visit the interactive site with a virtual furniture store, where all products are displayed virtually and virtual consultants can look after customers and, of course, this furniture can be ordered both for the virtual home and in the real world. As with a real site or their own home, site owners can give their imagination free rein when it comes to design and management. For orientation in this new world, a 3D world map of this world is created, which is displayed on the clients or devices, respectively, of the users. An associated search engine, which finds and displays properties, services, places, objects, in this world, can also be used by the user for orientation in the VRW 9. Here, there are public squares, roads and existing between the purchased land. The user can thus purchase a building, in particular a store, and place it on his or her property so that other users can visit and store in these buildings, if they are made publicly available, via the medium 9. In the process, a user can also attend free school lessons as well as paid courses.

Users can also provide their own educational content either free of charge or for a fee

In order to enable this use of the medium 9, i.e. the VRW medium 9 or application 9, respectively, to be used even by older devices, as shown schematically in FIG. 2, the method according to the present invention was created in which the medium 9 is invoked e.g. on an older, low-performance cellphone 17. Subsequently, the medium 9, in particular the VRW application 9, analyzes the performance data 18, as schematically shown, of the cellphone 17, and reconciles it with the information 16 stored in the VRW application 9, whereupon lacking resources are determined by the VRW application 9 via the internet 1. In the case of such older cellphones 17, often the graphics require a corresponding graphics card 19, such as provided on the computer 3, which is used by the VRW application 9 through a connection 19 via the internet 1. Also, it is often necessary for additional storage space 20 provided via the storage medium 15 to be utilized.

It can therefore be said that the required resources are determined, searched for and subsequently utilized by the medium 9, in particular the VRW application 9, so that even obsolescent devices can make use of the new virtual world 9. In order to enable smooth presentation, the VRW application 9 is formed by a plurality of data packets 8a to 8xx, wherein very fast and, above all, constant transmission over the internet 1 is achieved due to the small data volumes. Reloading of such data packets 8a to 8xx can also be performed at high speed.

It is pointed out that the invention is not limited to the embodiments shown, but may comprise further embodiments. In particular, the embodiments or individual features of the embodiments can also be combined with each other.

1. A method for controlling and regulating data for generating a representation, in particular a virtual representation, via a client, in particular a software, a browser, an app, on a medium, in particular a computer, tablet or cellphone, smart TV, VR glasses, etc., comprising:
Opening a client, in particular a software, a browser, or an app, at a medium;
Establishing a connection of the medium with a server, in particular a web server, via the internet;
requesting data, in particular by transmission of a protocol, and
Loading the data onto the medium for use by the client, wherein after opening the client or when requesting data from the internet, in particular a server, the client obtains access to the hardware of the executing medium, and the performance data of the medium are determined by the client or these performance data are transmitted from the medium to the client, whereupon the client compares the performance data of the medium with the resources required for the requested data, which are transmitted to the client by transmission of the protocol when the client makes the query, whereupon, if the performance data of the medium are too low, additional external performance resources of one or more users are activated by the client.

2. The method according to claim 1, wherein the lacking performance resources are distributed by the client to one or more users.

3. The method according to claim 1, wherein the data are processed by one or more users in parallel or sequentially when instructed by the client.

4. The method according to claim 1, wherein different users are activated for different performance resources, wherein users are activated for the performance resource for additional storage medium and/or a performance resource for additional computing power.

5. The method according to claim 1, wherein each user transmits to the client, upon a query from the client, information relating to the performance resources provided by the user.

6. The method according to claim 1, wherein when a user activates his or her performance resources for other users or media, respectively, he or she deposits his or her provided performance resource in a database on a server.

7. The method according to claim 1, wherein the client performs the distribution of the performance resources to a variety of users.

8. The method according to claim 1, wherein the request for the data is made via the Virtual Reality Transfer Protocol (VRTP).

9. The method according to claim 1, wherein the client is designed so that the data are split into several small data packets with low data volumes on several different servers, which are loaded sequentially or in parallel from the different servers when they are called up and then merged by the client.

10. A method for managing data on the interact for generating a representation, in particular a virtual representation, via a client, in particular a software, a browser, an app, on a medium, in particular a computer, tablet or cellphone, smart TV, VR glasses, etc., comprising:
Opening a client, in particular a software, a browser, or an app, at a medium;
Establishing a connection of the medium with a server, in particular a web server, via the internet;
requesting data, in particular by transmission of a protocol, and
Loading the data onto the medium for use by the client; wherein
the data are split into several small data packets with low data volumes on several different servers, which are loaded sequentially or in parallel from the different servers when they are called up and then merged by the client.

11. The method according to claim 10, wherein each data packet is stored several times, in particular in parallel, on several different servers, wherein the data packet is loaded from the server with the fastest data connection.

12. The method according to claim 10, wherein each data packet contains information 16, in particular server addresses, for the next data packet.

13. The method according to claim 10, wherein the medium from which a data packet is requested via the client serves as an additional storage medium for this or more data packets.

14. The method according to claim 10, wherein the request for the data is made via the Virtual Reality Transfer Protocol (VRTP protocol).

15. The method according to claim 10, wherein, the client is designed so that, after opening the client or when requesting data from the internet, in particular a server, the client obtains access to the hardware of the executing medium, and the performance data of the medium are determined by the client or these performance data are transmitted from the medium to the client, whereupon the client compares the performance data of the medium with the resources required for the requested data, which are transmitted to the client by transmission of the protocol when the client makes the query, whereupon, if the performance data of the medium are too low, additional external performance resources of one or more users are activated by the client.
